(19) United States
(12) Patent Application Publication
(10) Pub. No.: US 2003/0144978 A1
(43) Pub. Date: Jul. 31, 2003

(54) Automated learning parsing system

(76) Inventor: Hatem I. Zeine, Amman (JO)

Correspondence Address: Richard C. Litman, LITMAN LAW OFFICES, LTD., P.O. Box 15035, Arlington, VA, 22215, US

(21) Appl. No.: 10/338,003

(22) Filed: Jan. 8, 2003

Related U.S. Application Data
(60) Provisional application No. 60/348,606, filed on Jan. 17, 2002.

(51) Int. Cl. G06N 5/02; G06F 17/00

(52) U.S. Cl. 706/47

(57) ABSTRACT

An automated learning parsing system that utilizes a method for inferring context-free grammars. The automated learning parsing system utilizes two algorithms, a learning parser algorithm and a generic parser algorithm. The two algorithms are combined in such a way that the output of the first algorithm is the input to the second algorithm. The learning parser algorithm produces a grammar based on input data and the generic parser algorithm uses the induced grammar for identifying patterns depending on the application at hand.

### CROSS-REFERENCE TO RELATED APPLICATION

This application claims the benefit of U.S. Provisional Patent Application Serial No. 60/348,606, filed Jan. 17, 2002.

### 1. FIELD OF THE INVENTION

The present invention is an automated learning parsing system that relates to the fields of grammatical inference and syntactic pattern recognition, and in particular, the inference of context-free grammars.

### 2. DESCRIPTION OF RELATED ART

An alphabet is defined to be a finite set of fundamental units called symbols, out of which data structures are built. For an alphabet X, the set of all finite strings formed from symbols in X are denoted by X*.X⁺ denotes the set X−{λ} of all non-empty finite strings, where λ denotes the empty string. A “language” then consists of strings of symbols from the alphabet. Although these strings are of finite length, the language may or may not be finite. A grammar is defined as a four-tuple G=(N, T, P, S), where N is a finite set of non-terminal symbols, T is a finite set of terminal symbols, P is a finite set of production rules, and S is the start symbol. Each production rule pεP is of the form α→β, where αε(N∪T) and βε(N∪T)*.

The term “language” is used in a generic sense, however, the use of the term “language” should be noted as to describe any set of data, information, knowledge or patterns that can be used for a variety of applications.

A grammar provides a specification for the strings in the language. That is, a string that is in the language is a valid string, while a string that is not in the language is an invalid string. A recognition grammar is able to test the validity of a given string. That is, given an arbitrary string of symbols from the alphabet, the recognition grammar may be used to determine whether the string is in the language or not.

A grammar is considered context-free if any production rule is of the form A→z, where AεN and zε(N∪T)⁺. Context-free grammars were originally studied for modeling natural language. Later on, they were intensively used as models for programming languages and are used also in structural pattern recognition. Given a set of strings that the grammar is supposed to generate, the problem of inferring a grammar that satisfies these strings, in addition to satisfying unseen strings, is called the grammatical inference problem.

Grammatical inference is an important field of application research that has a wide range of applications, which include, but are not limited to, syntactic pattern recognition, computational biology, natural language acquisition, data mining, packet identification, user identification, document searching and categorization, data compression, textual structure detection, sentence structure recognition, medical applications, knowledge discovery and many other areas.

The subject of pattern recognition has been under intensive study during recent years. As a result, numerous research papers, as well as patents, have been published in the literature. However, the area of pattern (or knowledge) extraction is rarely mentioned anywhere in research papers or patent documents.

The pattern extraction feature is the ability to find or pull out patterns from given data sets with prior knowledge of patterns of interest. This problem becomes more challenging and important, if the pattern extraction feature can actually induce patterns from a given data set without any prior knowledge of its patterns, which indicates that the pattern extractor is able to construct the rules and grammars of the given data set (or language) under study. Depending on the specific data set of interest, the constructed rules or grammars may well be any set of strings of certain structures, such as URLs, dates, times, e-mail addresses, etc. The resultant rules and grammars can then provide the basis for the detection of patterns from a new data set taken from the same source. Accordingly, there is no need to “teach” the system about the syntax or structure of such patterns, since it gets automatically extracted, and eventually, detected and recognized.

There are a number of patents in the field of inference and syntactic pattern recognition and include the following related art.

U.S. Pat. No. 4,686,623, issued to Wallace, discloses a table-driven attribute parser for checking the consistency and completeness of attribute assignments in a source program. The parser is generated by expressing the syntax rules, semantic restrictions and default assignments as a single context-free grammar which is compatible with a grammar processor, or parser generator, and by processing the context-free grammar to generate an attribute parser, including a syntax table and parse driver.

U.S. Pat. No. 5,317,647, issued to Pagallo, discloses a method for defining and identifying valid patterns for use in a pattern recognition system. The method is suited for defining and recognizing patterns comprised of sub-patterns which have multidimensional relationships. The definition portion is represented by a constrained attribute grammar. The constrained attribute grammar includes non-terminal, keyword and non-keyword symbols, attribute definitions corresponding to each symbol, a set of production rules, and a relevance measure for each of the key symbols.

U.S. Pat. Nos. 5,481,650 and 5,627,945, issued to Cohen, permit various types of background knowledge for a concept learning system to be represented in a single formal structure known as an antecedent description grammar. A user formulates background knowledge for a learning problem into such a grammar, which then becomes an input into a learning system, together with training data representing the concept learned. The learning system, constrained by the grammar, then uses the training data to generate a hypothesis for the concept to be learned. The hypothesis is in the form of a set of logic clauses known as Horn clauses.

U.S. Pat. No. 5,487,135, issued to Freeman, outlines a rule based system concerned with a domain of knowledge or operations (the domain theory) and having associated therewith a rule-based entity relationship (ER) system (the ER theory), which represents the domain theory diagrammatically, and is supported by a computer system.

U.S. Pat. No. 5,748,850, issued to Sakurai, outlines a recognition system using a knowledge base in which there is a required tolerance for ambiguity and noises in a knowledge expressing system not having an existing cause and effect relation. The knowledge base supported recognition system includes as an inference engine an apparatus in which a hypergraph is added to the data structure of the knowledge base to obtain a minimum cost tree or the like by use of costs assigned to hyperedges of the hypergraph.

U.S. Pat. No. 5,796,926, issued to Huffman, outlines the use of a system provided for learning extraction patterns (grammar) for use in connection with an information extraction system. The learning system learns extraction patterns from examples of texts and events. The patterns can then be used to recognize similar events in other input texts. The learning system builds new extraction patterns by recognizing local syntactic relationships between the sets of constituents within individual sentences that participate in events to be extracted.

U.S. Pat. No. 5,802,254, issued to Satou et al., analyzes symbolized time series data in units of a case and extracts a causal relation included in the data as a rule representing a data structure. The time series data are stored as records of a symbol and a time by a symbolized data management apparatus, and a unit description of an analysis is determined by a case production apparatus and a classification apparatus.

U.S. Pat. No. 6,038,560, issued to Wical, outlines the use of a knowledge base search and retrieval system, which includes factual knowledge base queries. A knowledge base stores associations among terminology and categories that have a lexical, semantical or usage association. Document theme vectors identify the content of documents through themes as well as through classification of the documents, in categories that reflect what the documents are primarily about.

U.S. Pat. No. 6,061,675, issued to Wical, outlines the use of a knowledge catalog that includes a plurality of independent and parallel static ontologies to accurately represent a broad coverage of concepts that defines knowledge. The actual configuration, structure and orientation of a particular static ontology is dependent upon the subject matter or field of the ontology in that the ontology contains a different point of view. The static ontologies store all senses for each word and concept. A knowledge classification system that includes a knowledge catalog is also disclosed.

U.S. Pat. No. 6,173,441, issued to Klein, outlines a method and system for compiling source code containing natural language declarations, natural language method calls, and natural language control structures into computer executable object code. The system and method allow the compilation of source code containing both natural language and computer language into computer-executable object code.

Japanese Patent No. JP 3-148,728 describes generating a parser to dynamically cancel conflict by adding information to grammar data so as to instruct whether the conflict is dynamically canceled or not.

Japanese Patent No. JP 5-189,242 describes an automatic generation method for a parser with which a construction can accurately be analyzed, even if there is fuzzy grammar, by deciding a next action by means of a prescribed reference when a conflict occurs.

Although each of these patents outlines the use of novel and useful systems and methods, what is really needed is a system and method with a pattern extractor that can actually induce patterns from a given data set without any prior knowledge of its patterns, which indicates that the pattern extractor is able to construct the rules and grammars of the given data set (or language) under study. In other words, there is no need to teach a system about the syntax or structure of such patterns, since it gets automatically extracted and eventually detected and recognized. Such a system has significant value in the fields of inference and pattern recognition.

None of the above inventions and patents, taken either singly or in combination, is seen to describe the instant invention as claimed.

### SUMMARY OF THE INVENTION

The present invention is an automated learning parsing system that utilizes a method for inferring context-free grammars. The automated learning parsing system utilizes two algorithms, viz., a learning parser algorithm and a generic parser algorithm. The two algorithms are combined in such a way that the output of the first algorithm is the input to the second algorithm. The learning parser algorithm produces a grammar based on input data and the generic parser algorithm uses the induced grammar for identifying patterns depending on the application at hand.

Accordingly, it is an object of the invention to extract and recognize patterns that contain meaning relevant for an application and to further act on that information in an application-specific way.

It is an object of the invention to describe a new parsing concept that is based on artificial intelligence pattern recognition and grammatical inference techniques and technologies.

It is another object of the invention to provide an automated learning parsing system which takes an arbitrary data set and induces its pattern structures for various applications.

It is a further object of the invention to provide an automated learning parsing system which utilizes an inference engine that is able to detect and recognize patterns based on rules previously extracted from similar data by the pattern extraction system.

It is an object of the invention to provide improved elements and arrangements thereof in the automated learning parsing system for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram showing a system overview of an automated learning parsing system according to the present invention.

FIG. 2 is a block diagram of the overall method steps used by the automated learning parsing system.

FIG. 3 is a parsing tree structure for the automated learning parsing system.

FIG. 4A is a parsing tree structure for the automated learning parsing system generated from an input data set.

FIG. 4B is a second parsing tree structure for the automated learning parsing system generated from an input data set.

FIG. 4C is a third parsing tree structure for the automated learning parsing system generated from an input data set.

FIG. 5 is a parsed leaf table for an input data set generated by the generic parser algorithm of the automated learning parsing system showing the relationship of the parsed leaf table to a cell offset array.

FIG. 6A is a parsed leaf table for an input data set generated by the learning parser algorithm of the automated learning parsing system showing an alternative format for a parser leaf table.

FIG. 6B is a parsed leaf table for an input data set generated by the learning parser algorithm utilizing a rule packet array of the automated learning parsing system.

Similar reference characters denote corresponding features consistently throughout the attached drawings.

### DETAILED DESCRIPTION OF THE PREFERRED EMBODIMENTS

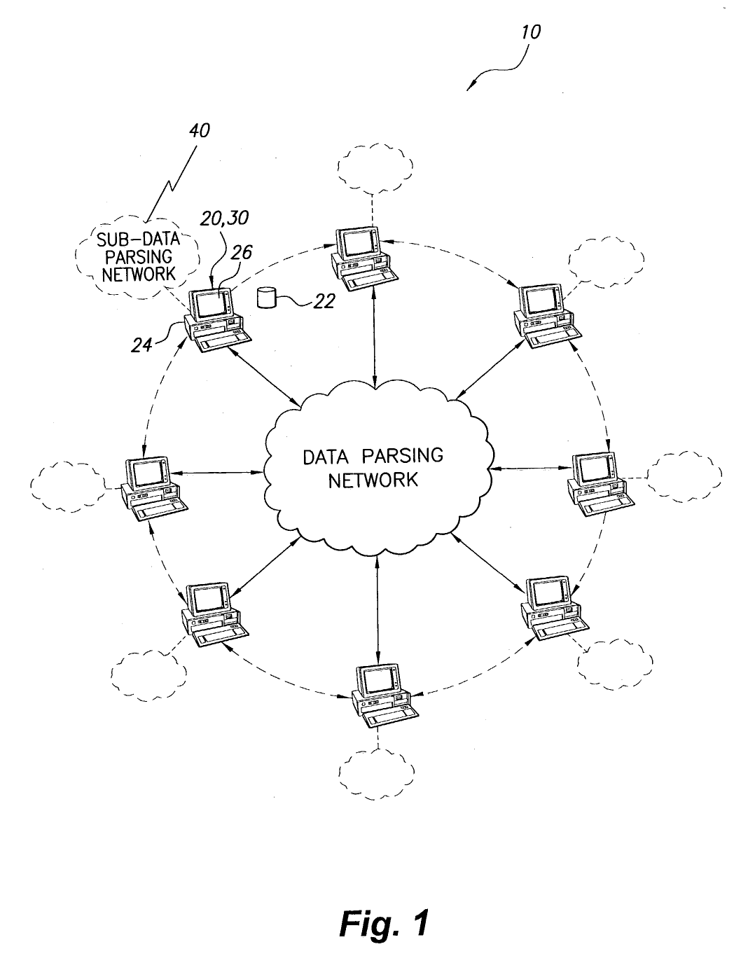

The present invention is an automated learning parsing system 10 that relates to the fields of grammatical inference and syntactic pattern recognition, and in particular, the inference of context-free grammars. An overview of the automated learning parsing system 10 is depicted in FIG. 1.

As diagrammatically illustrated in FIG. 1, the automated learning parsing system 10 comprises one computer network system 20 having a parsing station network 30 and a respectively linked subdata parsing network 40 for automatically learning and generating grammar from at least one remote or local input data set. The computer network system 20 has at least one resident data storage facility 22, a microprocessor 24, and a display monitor 26. The computer network system 20 has at least one computer, the parsing station network 30 has at least one parsing station and the subdata parsing network 40 has at least one subdata parsing station.

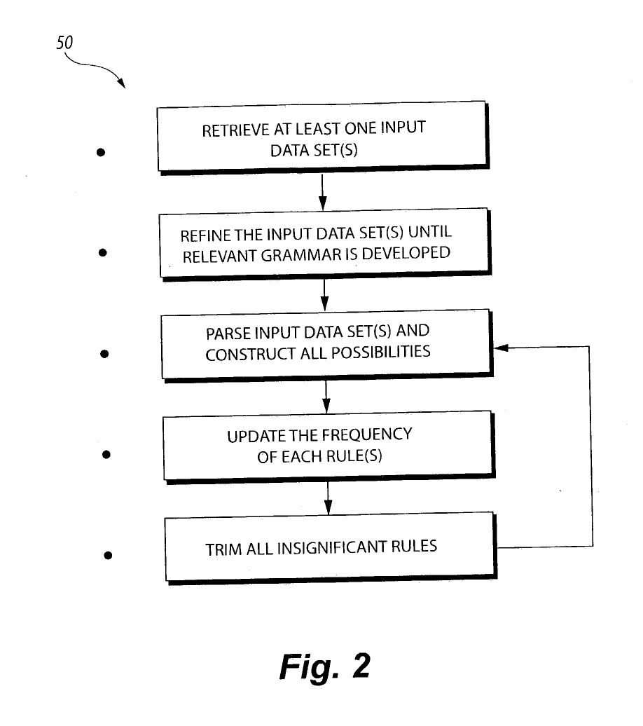

FIG. 2 depicts the steps involved with the overall method 50 utilized by the automated learning parsing system 10. The steps include retrieving at least one input data set, refining the input data set until relevant grammar is developed via a subroutine loop comprising the following three steps: parsing the data set and constructing all possible rules, updating the frequency of each rule and trimming all insignificant rules. Each of these steps is discussed in detail throughout the remainder of this application.

The automated learning parsing system 10 utilizes two algorithms, a learning parser algorithm and a generic parser algorithm. The two algorithms are combined in such a way that the output of the learning parser algorithm is the input to the generic parser algorithm. The learning parser algorithm produces a grammar based on input data and the generic parser algorithm uses the induced grammar for identifying patterns depending on the application at hand.

The following represents the steps of the learning parser algorithm:

Loop until getting a relevant optimized grammar{

LPParse parses the input string and constructs all possible rules (patterns)

LPUpdateFrequency updates the frequency of each rule

LPTrim trims all insignificant rules (patterns)

}

Main Data Structures are developed and are based upon rules or grammars for a given data set. Every rule consists of five integer components:

Derived code.

Left side code.

Right side code.

Frequency of the rule.

Scope of the rule, which is the length of the rule sub-string.

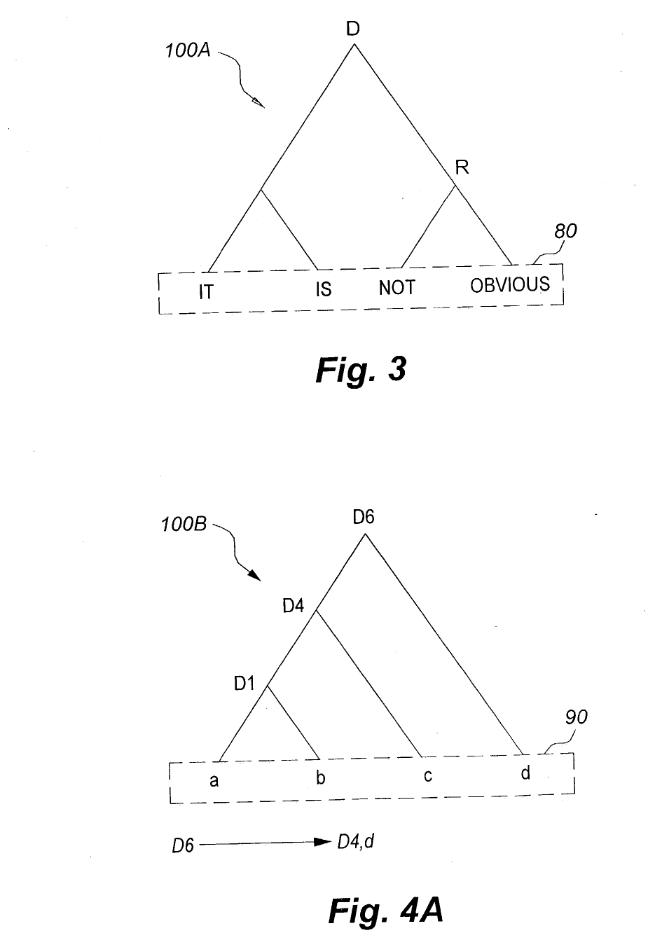

As diagrammatically illustrated in FIG. 3, the rule D→L, R has:

D as a derived code,

L as a left side code, and

R as a right side code.

The rule substring or data set 80 is “It is not obvious” and the scope of the rule in the form of word elements is 4. Notably, the alphabet of the language is the set of English language words. According to this particular example, the structure used to store a rule is called a rule packet.

Rules can be stored in any database using many different ways. In this implementation, rule packets are stored in an array called a rule packet array. The array can be thought of as a collection of rule blocks. All rules in the same block have the same right side code. There are also possibly gaps between blocks. These gaps allow for rule additions without major reshaping of the array, and are used for housekeeping of the arrays and performance issues.

There are many different ways to search for and locate a rule. In the implementation at hand, the search for a rule is not performed directly. Instead, there is a second array called a sort packet array. Each sort packet in this array holds the following information for a rule block:

The right side code of the block.

The starting position (offset) of the block in the rule packet array.

The number of rules in the block.

Each element in the second array is called a sort packet. The sort packet array is sorted by right side code. The sort packet array serves as an index to the rule packet array. Searching for a rule in this context means “What is the derived code's, if any, for a given right side code and a given left side code?”. Whenever the program needs to search for a rule, it will do it in two separate steps. First, the sort packet array is searched for the right side code resulting in the rule block offset and size. Second, a search for the left side code is performed on the block.

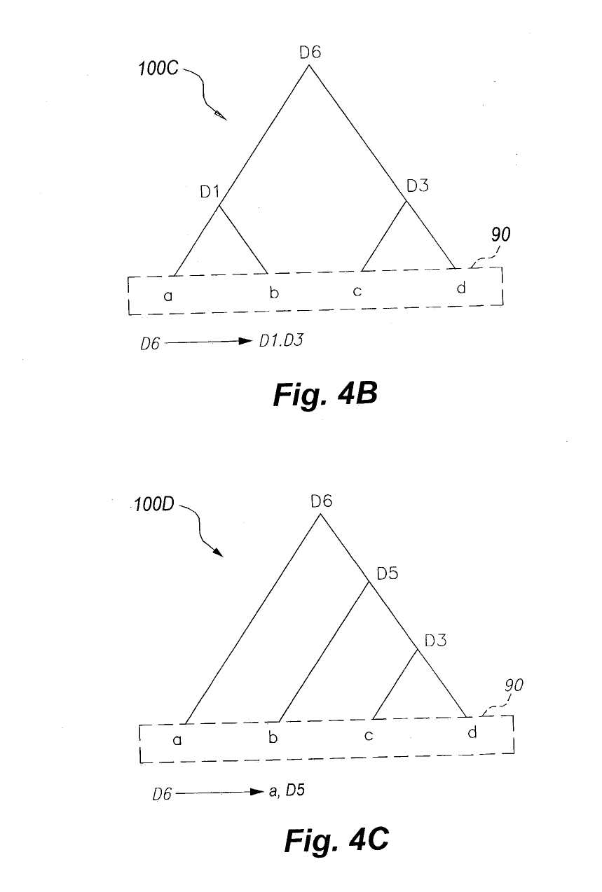

The following contains a description of the learning parser algorithm. It provides an overview of the several data tree structures for several rules and pseudo-code for the learning parser algorithm. Note that an empty string will be denoted by _EMP. In operation, at least one data input set 80 is selectively retrieved within either a parsing network 30 and/or a subdata parsing network 40. The parsing features of the automated learning parsing system 10 are diagrammatically illustrated by the data tree structures 100A, 100B, 100C and 100D in FIGS. 3, 4A, 4B and 4C respectively.

Briefly, the automated learning parsing system 10 scans the input data set 80 position by position. For each position cell, the automated learning parsing system 10 stores the leaves pertaining to the position as in the LPParse function. The LPParse function parses the input string and constructs all possible rules of each substring. Given that the input size is n, the number of all possible learning parser rules is (n³−n)/6. The term “all possible rules” is clarified in the following examples as diagrammatically illustrated in FIGS. 4A, 4B and 4C.

Given the input string or data set 90 is “abcd”, where the alphabet of the language is the set of English language letters, LPParse will output the following rules:

D1→a, b

D2→b, c

D3→c, d

D4→D1, c

D4→a, D2

D5→D2, d

D5→b, D3

D6→D4,d

D6→D1, D3

D6→a, D5

FIGS. 4A, 4B and 4C illustrate all rules of scope 4 related to the word string “abcd” (i.e., D6 rules of the above rules). Accordingly, the following represents the pseudo-code of the LPParse function:

1. For each cell x in the input data{

2. Create a parse leaf for x

(leaf_array[current_leaf].instantiated = x;

leaf_array[current_leaf++].termination=current_position−

1)

3. For leaf1 = current_leaf to last_leaf_stored{

4. Search for leaf_array[leaf1].instantiated as right side code
5. If found{

6. For each leaf leaf2 in the block whose current position =
leaf_array[leaf1].termination{

7. Search for leaf_array[leaf2].instantiated as left side code
8. If found

9. Create leaves for each rule

φ → leaf_array[leaf2].instantiated, leaf_array[leaf1].instantiated
(leaf_array[current_leaf].instantiated = φ;
leaf_array[current_leaf++].termination =

leaf_array[leaf2].termination)

10. Else{
11. Add new rule{

12. (χ → leaf_array[leaf2].instantiated leaf_array[leaf1].instantiated)

where χ is a new

rule number (new derived code)

13. Search for rule with the same sub-string of rule χ above

14. If such rule is found with π as a derived code
15. Replace χ with π so that the two rules have the same rule number
(derived code) π
16. Compute the scope of the rule

}

}

}

}

17. Else{

18. For each leaf leaf2 in the block whose current_position=

leaf_array[leaf1].termination{
19. Add new rule{

20. (χ → leaf_array[leaf2].instantiated,leaf_array[leaf1].instantiated)
where χ is a new rule number (new derived code)
21. Search for rule with the same sub-string of rule χ above
22. If such rule is found with π as a derived_code

23. Replace χ with π so that the two rules have the same rule

number

(derived_code) π
24. Compute the scope of the rule

}

}

}

}

}

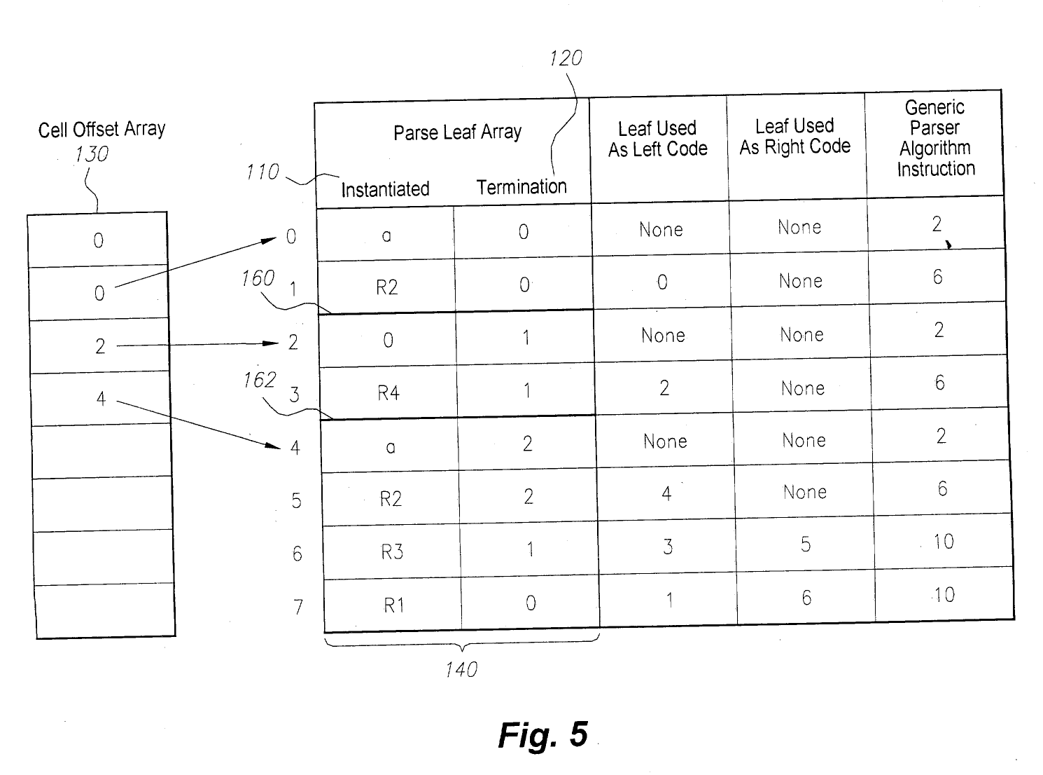

As is shown in FIG. 5, every parse leaf is made up of an instantiated code 110 and a termination cell position 120 in the input data. The instantiated code 110 is a derived code corresponding to the substring starting from the termination cell position 120 to the current position. Notice that the termination cell position 120 is actually the starting position of the subinput being instantiated. The direct result of parsing is an array of parse leaves filled with values. Having a parse leaf with instantiated code 110 and a termination cell 120 indicates that the automated learning parsing system 10, after scanning the input data from position 120 until the current position, derived the instantiated code 110. At a certain cell position, there could be more than one parse leaf. The current position is not stored explicitly. Instead, there is another array called cell offset array that keeps track of current positions. Each element in this array is called a cell offset and points to the starting position of a block of parse leaves. The common thing for all leaves in the same block is the current cell position. For example, element 0 in the cell offset array 130 points to the first leaf in the block whose current position is 0.

The approach taken to represent the position of a cell is just the normal approach used in C programming language to start arrays at zero position. For example, if the input data is “abcd”, then the string occurs from position 0 to position 4. This indicates that there are 5 unmistaken positions of cells instead of 4 positions of cells. Each cell has a starting position and an ending position (=starting position+1) where the starting position is initialized to 0.

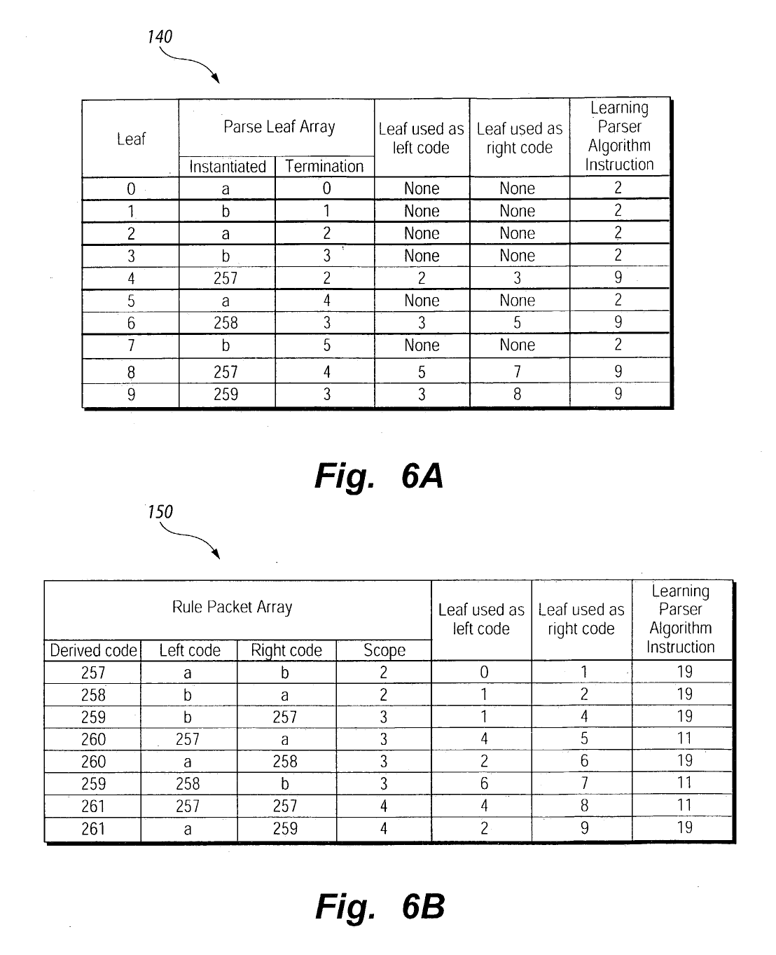

In an alternative format, parsing can be formulated in tabular form as illustrated below using the input data “ababab”. FIGS. 6A and 6B show the result of parsing via a respective parse leaf array 140 and rule packet array 150 obtained from the result of running LPParse function once on the input string “ababab”. In this example, it was assumed that the value of the first derived code is 257, the second is 258 and so on. In FIG. 6A, blocks of parsed leaves are separated by thick lines. For FIG. 6A, the results are tabulated in a similar way as described for FIG. 5. The data tabulated in FIG. 6B is illustrative of the parsing techniques described in FIGS. 3, 4A, 4B and 4C using a rule packet array 150.

There is also an LPUpdate Frequency function that parses the input data and updates the frequency of each rule in the rule packet array 150. For example, if the input string is “abab”, then the frequency of the rule D2→b, a is equal to 1, while the frequency of the rule D143 a, b is equal to 2. Additionally, there is also an LPTrim function that trims all insignificant rules out of the rule packet array 150 and the remaining rules would be the desired patterns. It should be noted that the definition of the insignificance of a rule depends on the application, be it an Internet-related URL, an e-mail address, or other application. In general, this definition would be a mathematical relation that depends on the scope and the frequency of the rule. This function can be used to provide for the unlearn feature.

The automated learning parsing system 10 also has a generic parser algorithm that is used with the learning parser algorithm. A simple example of applying the generic parser algorithm is provided. Apart from the structure of the generic parser algorithm rules, which do not have the frequency and scope fields, the generic parser algorithm has the same data structure as that of the learning parser algorithm. The input of the generic parser algorithm is a grammar, which is a set of rules stored in the rule packet array (whether it is given or induced by the learning parser algorithm), and a string that will be parsed against the stored grammar. The output is parsed leaves stored in the parse leaf array 140. The generic parser algorithm pseudo-code includes the following:

1. For each cell x in the input data{
2. Create a parse leaf for x(leaf_array[current_leaf].instantiated = x;

leaf_array[current_leaf++].termination =

current_position − 1)

3. For leaf1=current_leaf to last_leaf_stored{
4. Search for _EMP as right side code
5. If found
6. Create leaves for each rule

φ → leaf_array[leaf1].instantiated, _EMP

(leaf_array[current_leaf].instantiated = φ;
leaf_array[current_leaf++].termination=
current_position−1)

7. Search for leaf_array[leaf1].instantiated as right side code
8. If found

9. For each leaf leaf2 in the block whose current position =

leaf_array[leaf1].termination

10. Create leaves for each rule

φ → leaf_array[leaf2].f2].instantiated,

leaf_array[leaf1].instantiated

(leaf_array[current_leaf].instantiated = φ;

leaf_array[current_leaf++].termination =

leaf_array[leaf2].termination)

}
}

An example of the input structure can be seen in the following input grammar and input data set for the generic parser algorithm:

Input Grammar:

R4→0, _EMP

R4→1, _EMP

R2→a, _EMP

R3→R4, R2

R1→R2, R3

Input Data:

“a0a”

The result of parsing is illustrated by the cell offset array 130 and the parse leaf array 140 features of FIG. 5. As is shown in FIG. 5, blocks of parsed leaves are separated by thick lines 160 and 162.

One of the primary advantages and points of novelty of the automated learning parsing system 10 is that it automatically creates, learns and detects grammar for any data, information, knowledge, language or pattern base by going through enough samples of data and automatically uses an induced grammar to identify and recognize certain patterns without user intervention.

In summary, the power of the learning parser algorithm and generic parser algorithm combination is that the generic parser algorithm is a, lightweight generic parser algorithm, whereas the learning parser algorithm is capable of automatically generating grammars for the generic parser algorithm to parse against by parsing representative samples of data that conform to the patterns to be recognized. There are many possible ways to represent the data for the grammars and to implement the learning parser algorithm and the generic parser algorithm and their data structures, but all provide the same functionality. The code and grammar structure of the learning parser algorithm lends itself easily to the adaptation of unlearning features, in which the learning parser algorithm can cater for unlearning (forgetting) a certain grammar rule (or rules) when necessary. This feature, in addition to the trimming algorithm (not shown), helps in producing an optimized, relevant grammar. The generic parser algorithm is an algorithm that performs the process steps of identifying the strings of a language by parsing it against a predefined grammar. In other words, the generic parser algorithm is provided with the definition of a certain concept, and it can recognize its instances. In this sense, the generic parser algorithm is a meta-code, since providing the generic parser algorithm with a definition of a new concept (e.g., what's a URL, an e-mail address, and dates), which is equivalent to writing a separate code for identifying that concept. Although the generic parser algorithm is an excellent tool by itself, it gains its power when combined with the learning parser algorithm. The learning parser algorithm induces a grammar of a language, and the generic parser algorithm automatically uses the induced grammar for identifying the strings of that language by deciding whether it conforms to the given attributes or not.

It is to be understood that the present invention is not limited to the sole embodiments described above, but encompasses any and all embodiments within the scope of the following claims.

I claim:

1. An automated learning parsing system, comprising:
a computer network system having a parsing station network and a parsing subdata network for automatically learning and generating grammar and rules from at least one input data set(s), said computer network system having at least one resident data storage facility, a microprocessor and a display monitor;
a learning parser algorithm stored on said computer network system and operating under the direction of said microprocessor, the learning parser algorithm including:
an LPParse function means for parsing the input data set and constructing all possible rules;
an LPUpdateFrequency function means for updating the frequency of occurrence of each rule; and
an LPTrim function means for removing all insignificant rules;
a generic parser algorithm stored on said computer network system and operating under the direction of said microprocessor to use the induced grammar for identifying patterns depending on the application at hand; and
said input data set that is selectively retrieved from the parsing station network and the parsing subdata network, which is able to automatically read and learn the given input data and generate the grammar and rules describing the structure of said input data set.

2. The system according to claim 1, wherein every grammar or rule has a derived code, left side code, right side code, frequency of the rule and scope of the rule.

3. The system according to claim 1, wherein the grammar and rules are stored in a resident data storage facility in the form of a rule packet array.

4. The system according to claim 1, wherein the grammar and rules are searched for according to a sort packet array.

5. The system according to claim 1, wherein the grammar and rules are positioned according to a cell offset array.

6. The system according to claim 1, wherein every parse leaf is made up of an instantiated code and a terminal cell position.

7. The system according to claim 1, wherein parsing can be formulated in tabular form.

8. The system according to claim 1, wherein the learning parser algorithm is capable of automatically generating grammars for the generic parser algorithm to parse against by parsing representative samples of the input data set that conform to recognized patterns.

9. The system according to claim 1, wherein said system automatically creates, learns and detects grammar for any data, information, knowledge, language or pattern base by processing the input data set and automatically using an induced grammar to identify and recognize certain patterns without user intervention.

10. A method for inferring context-free grammars, comprising the steps of:
retrieving at least one input data set;
refining the input data set until relevant grammar and rules are developed via a loop comprising the steps of:
parsing input data set and constructing all possibilities;
updating the frequency of each grammar and rule; and
trimming all insignificant grammar and rule.
